(19) United States
(12) Patent Application Publication
(10) Pub. No.: US 2015/0213709 A1
(43) Pub. Date: Jul. 30, 2015

(54) LONG LIFE CONTAINER TRACKING DEVICE

(71) Applicant: Hirschmann Car Communication Inc., Auburn Hills, MI (US)

(72) Inventors: Alan Miller, Milan, MI (US); Syed Bilal Ul Haq, Rochester Hills, MI (US); Frank Homann, Shelby Township, MI (US)

(21) Appl. No.: 14/610,211

(22) Filed: Jan. 30, 2015

Related U.S. Application Data
(60) Provisional application No. 61/933,661, filed on Jan. 30, 2014.

(51) Int. Cl. G08B 25/10; H02J 7/00; H02J 7/35

(52) U.S. Cl. CPC G08B 25/10; H02J 7/35; H02J 7/007; H02J 7/345

(57) ABSTRACT

A tracking device is provided for tracking the location of a container. The tracking device comprises a communication system and a power system, the power system having a renewable energy system and a battery system. The renewable energy system is connected in parallel with the battery system across a first node. The battery system comprises a permanent, non-rechargeable battery connected in parallel with a rechargeable supercapacitor across a second node electrically connected to the first node. A battery diode is interposed between the first node and the renewable energy system and arranged to prevent the renewable energy system from drawing current from the battery system. A solar diode is interposed between the second node and the permanent battery, and is arranged to prevent current being supplied to the permanent battery such that the renewable energy system may charge the supercapacitor without damaging the permanent battery.

### CROSS-REFERENCE TO RELATED APPLICATIONS

This application claims the benefit of U.S. Provisional Application No. 61/933,661, filed Jan. 30, 2014, which is hereby incorporated by reference in its entirety.

### FIELD OF THE INVENTION

The present invention relates generally to container tracking, and more particularly relates to extending the life of container tracking devices.

### BACKGROUND

A variety of different products are transported in shipping containers. Products are packed into the container by a shipper, and then the container doors are closed and secured with some type of lock. The locked container is then transported to a destination, where a recipient removes the lock and unloads the container.

It is often advantageous to the shipper if some form of monitoring can be carried out while the container is being transported. As one example, containers may become lost or stolen, and thus many shippers own more containers then they need since the location of some containers will be unknown. The ability to accurately track the current location of the container as it travels from the shipper to the recipient helps ensure high usage rate and prevent the container from becoming lost. The cargo in the container may also include relatively valuable products such as computers or other electronic devices, and accurate location information can be of great importance.

It is not cost-feasible to have a person watch a container at all times in order to provide security and/or monitoring. Accordingly, electronic systems have previously been developed to provide a degree of automated security and/or monitoring. Since the containers may be carried on ships, railcars or trucks, they may not have access to an external power source, and thus include a battery system. Unfortunately, many of these electronic tracking systems have a short life of less than 5 years, often due to a loss of power or degradation of the components, and/or existing systems require maintenance and battery recharging/replacement to extend the life of each system.

### SUMMARY

The invention may include any of the following aspects in various combinations and may also include any other aspect described below in the written description or in the attached drawings.

In a first aspect, a tracking device is provided for tracking the location of a container. The tracking device comprises a communication system and a power system, the power system having a renewable energy system and a battery system. The communication system identifies the location of the container and communicates the location thereof. The power system supplies power to the communication system. The renewable energy system is connected in parallel with the battery system across a first node, and the first node is electrically connected to the communication system. The battery system comprises a permanent, non-rechargeable battery connected in parallel with a rechargeable supercapacitor across a second node. The second node is electrically connected to the first node. A battery diode is interposed between the first node and the renewable energy system and arranged to prevent the renewable energy system from drawing current from the battery system. A solar diode is interposed between the second node and the permanent battery, and is arranged to prevent current being supplied to the permanent battery such that the renewable energy system may charge the supercapacitor without damaging the permanent battery.

According to more detailed aspects, the supercapacitor is a hybrid layer capacitor (HLC). The permanent battery has a maximum voltage that is lower than a maximum voltage of the supercapacitor. The permanent battery has an open circuit voltage that is lower than the open circuit voltage of the supercapacitor when the supercapacitor is fully charged. The battery system has a positive terminal connected to the first node for outputting current. The battery diode is preferably an ideal diode, and optionally the solar diode is an ideal diode. The device may also include a voltage regulator for receiving current from an external power source. The voltage regulator is connected in parallel to the renewable energy system and the battery system across the first node. An external power diode is preferably positioned between the voltage regulator and the first node to prevent the voltage regulator from drawing current from either the battery system or the renewable energy system. The permanent battery is preferably one of a lithium thionyl chloride battery, a lithium sulfuryl chloride battery, or a lithium bromine chloride battery. The permanent battery has maximum pulse current that is insufficient for powering the communication system and microcontroller.

In a second aspect, a method of powering a tracking device for tracking the location of a container is provided. The method includes providing a communication system and a power system such as those described above and later herein. The method further includes determining a voltage level of the supercapacitor, and controlling the battery diode and solar diode based on the voltage level of the supercapacitor and an available power from the renewable energy system. According to more detailed aspects, the step of controlling the battery diode and solar diode prevents charging of the supercapacitor from the permanent battery when there is power available from the renewable energy system. When the power system includes a battery charger controller having temperature information, the step of controlling the battery diode and solar diode is further based on the temperature information. The method may also include controlling an external power diode based on the voltage/charge level of the supercapacitor and available power from the external source. The battery charger controller for the renewable energy source, and/or a controller for the communication system and/or power system, can also use parameters and inputs such as system voltages (e.g. of the permanent battery and/or the supercapacitor), the charging state, the availability of renewable energy (e.g. solar power) or external power, the state of the communication system, or the temperature (e.g. above or below recommended charging temperature ranges) to enable or disable the battery diode, the renewable energy diode, or the external power diode.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective of an embodiment of the container tracking device attached to a container, constructed in accordance with the teachings of the present invention;

FIG. 2 is a perspective view of the tracking device of FIG. 1;

FIG. 3 is an exploded perspective of the tracking device of FIG. 1;

FIG. 4 is a partial perspective view, cut away, of the tracking device of FIG. 1;

FIG. 5 is a partial perspective view of the tracking device of FIG. 1;

FIG. 6 is a partial perspective view, cut away, of the tracking device of FIG. 1;

FIG. 7 is a schematic of the tracking device of FIG. 1;

FIG. 8 is a schematic of the power system forming a part of the tracking device of FIG. 1; and

FIG. 9 is a schematic of another embodiment of the power system forming a part of the tracking device of FIG. 1.

### DETAILED DESCRIPTION

As discussed above, the present application is generally directed towards the tracking of containers, which as used herein includes all types of containers or receptacles for moving objects, including trailers, crates, pallets and related vehicles such as trucks, cargo vans, planes, ships, and all forms of shipping containers. It will be recognized by those skilled in the art that the tracking device may be attached and used with a wide variety of such containers and motive objects, especially larger containers hauled by trucks, trains and placed on boats, as well as stationary objects such as mounting or placing the tracking device in a remote area with no power, the device having a sensor to report a sensed parameter such as temperature, etc.

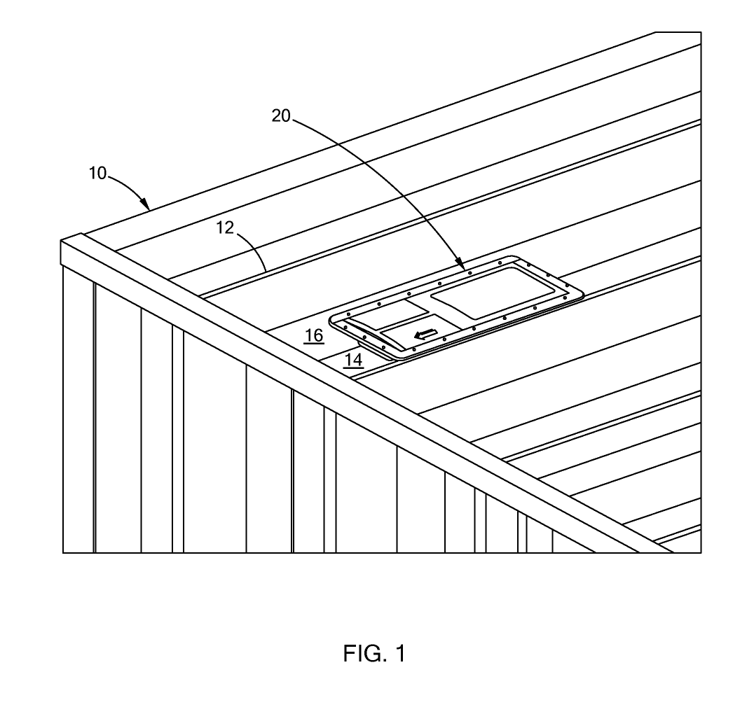

FIG. 1 depicts a container 10 having a tracking device 20 constructed in accordance to the teachings of the present invention. Through the combination of features described below, including noted improvements in power supply and management, the tracking device 20 exhibits a long life of 10 to 20 years or more without maintenance or service (including without connection to an external power source), which has not yet been accomplished by a tracking device in the industry.

The container 10 generally includes a series of corrugations 12 defined by at least a bottom wall 14 connected between opposing sloped walls 16. The tracking device 20 is sized and shaped to fit within these corrugations 12 so as not significantly project from an outermost horizontal plane of the container 10, and therefore preferably has a height about 35 mm or less. A preferred construction of the device 20 has a lower surface width of about 70 mm or less, a length of about 350 mm, and a height of about 33 mm or less. Preferably, the contour of the sides and bottom surface of the device 20 matches the shape of the bottom wall 14 and sloped sidewalls 16 of the corrugation 12. While the device 20 has been shown mounted to the roof (top wall) of the container 10, it will be recognized by those skilled in the art that the device 10 may be mounted to any surface, exterior or interior, of the container 10, such as a side wall or rear door panel where projection above the corrugations is less of a concern.

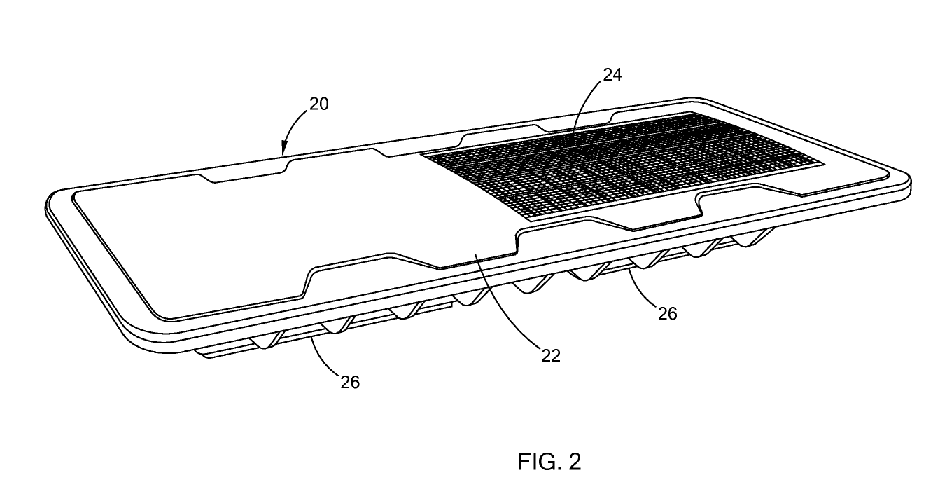

As best seen in FIG. 2, the tracking device 20 generally includes a housing 22 for encasing and protecting the electrical components of the device. The housing 22 incorporates a photovoltaic solar panel 24 into the exterior surface thereof. The solar panel 24 is preferably formed by a flexible sheet containing amorphous silicon (a-Si) technology that is light-weight, robust, and works in low light conditions. The solar panel 24 preferably has an output voltage of 3.6 V to 4.8 V, an output current of approximately 100 mA, and a power output of approximately 0.36 W to 0.48 W. The output voltage of the solar panel 24 is preferably equal to or higher than a maximum voltage of the supercapacitor 142, discuss further hereinbelow. A preferred size of the solar panel 24 is approximately 90 mm by 145 mm. The PV cells are embedded between layers of encapsulation materials such as ETFE (Ethylene Tetrafluoroethylene), which is highly light transmissive, has very high scratch resistance and is self-cleaning due to low frictional resistance. The lower (non-exposed) protective layer may be formed from thermoplastic polyurethane (TPU).

The housing 22 is preferably injection molded of a plastic that exhibits the durability, flexibility, and strength to last the life of the device 20. The solar panel 24 may be insert molded into the housing 22. Plastics such as polycarbonate (PC), acrylonitrile styrene acrylate (ASA), acrylonitrile butadiene styrene (ABS), filled polypropylene (PP), polyvinylchloride (PVC), and Nylon, or blends thereof, may be used to form the housing 22.

The tracking device 20, and in particular a bottom surface of its housing 22, is preferably attached to the container 10 using one or more adhesive tapes 26. A preferred adhesive tape is a dual sided tape for automotive applications. Other adhesives, tapes, magnets, mechanical fasteners and the like may be employed as is known in the field.

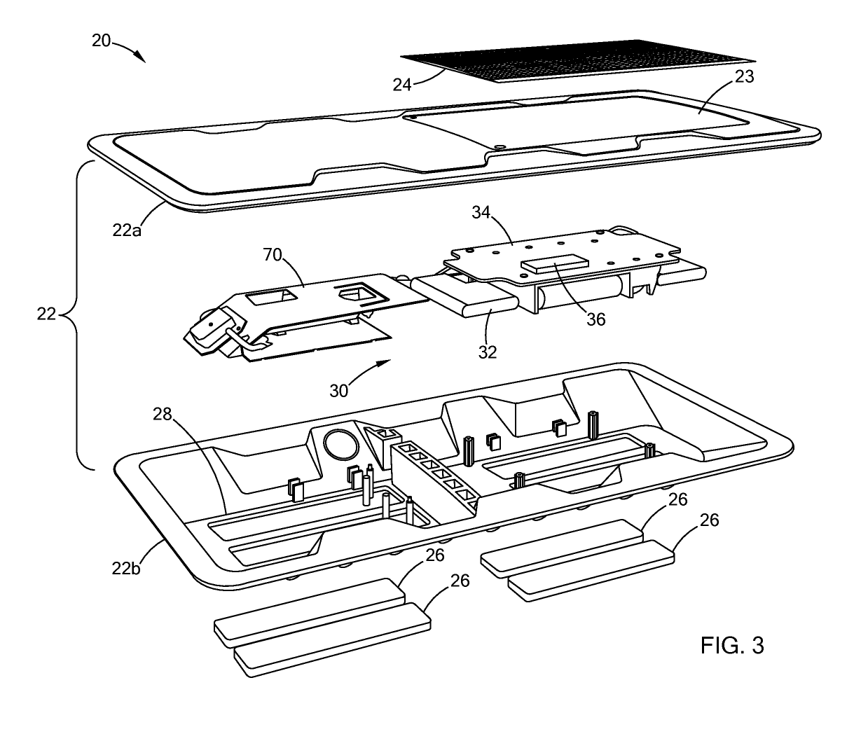

Turning now to FIG. 3, an exploded view of the tracking device 20 is shown. The housing 22 generally includes a lid 22a having a thin recessed area 23 for receiving the solar panel 24 and a through-hole for wiring. The housing body 22b generally defines an interior space 28 for receiving various components of the device 20, such as an antenna 70 forming part of the communication system 30, a power system 32, and a printed circuit board (PCB) 34 for related electrical components including a microprocessor 36.

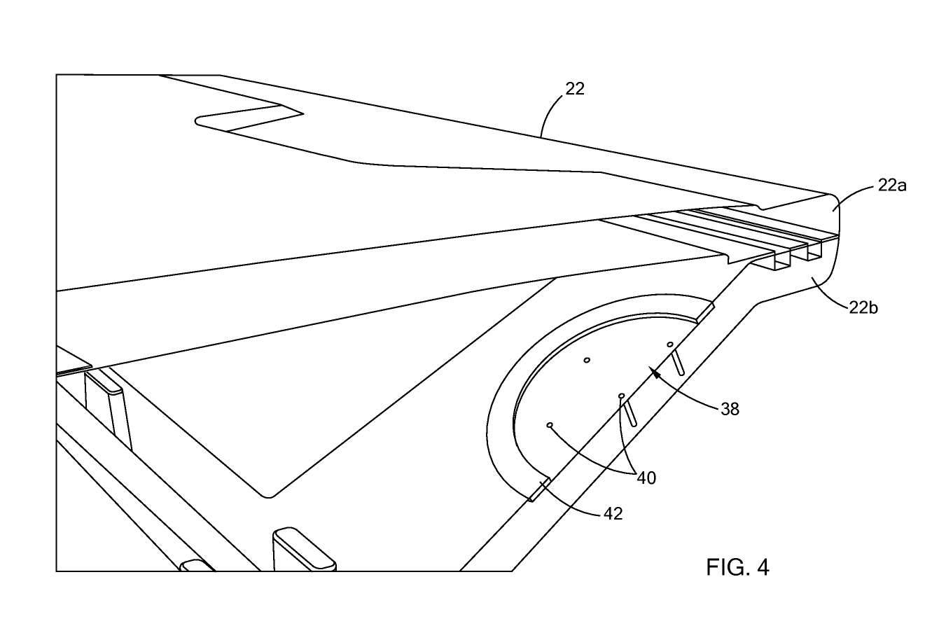

As seen in FIG. 3 and the cut-away of FIG. 4, the lid 22a of the housing is preferably hermetically sealed to the body 22b through plastic welding techniques, such as vibration welding or hot plate welding, preferably utilizing two parallel ribbed/channel structures, each of which extends circumferentially around the outer edge of the lid 22a and body 22b. Many techniques may employed for sealing the two components together including latches, tongue and groove, mechanical fasteners with gaskets, and adhesives. Since the housing 22 is hermetically sealed, it preferably includes a vent 38 formed by a plurality of small passageways 40 formed through the wall of the body 22b, along with a membrane vent 42.

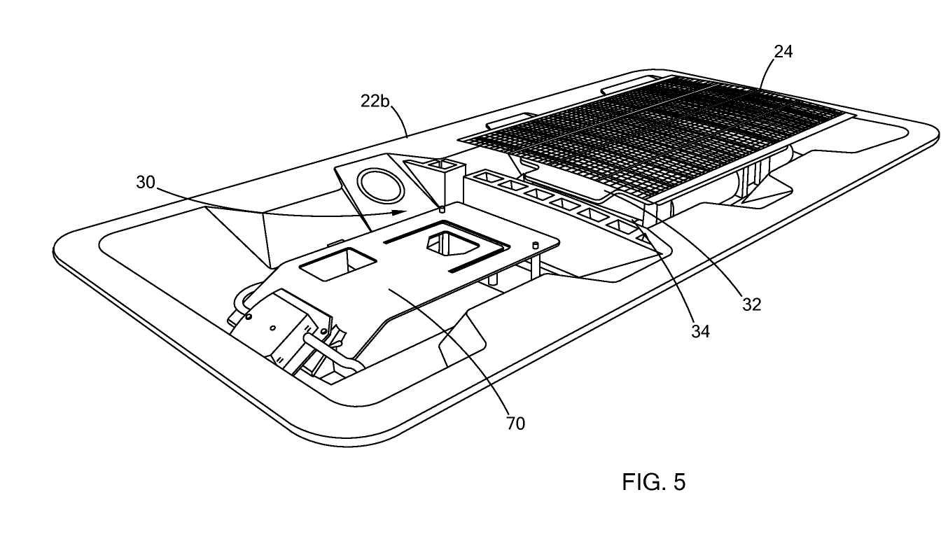

Turning now to FIG. 5 the housing body 22b is shown with the communication system 30, antenna 70, power system 32, and PCB 34 with related electronics as described further hereinbelow. The solar panel 24 has also been shown superimposed above the PCB 34. Various structures are molded in the body 22b for mechanical attachment of these systems and components.

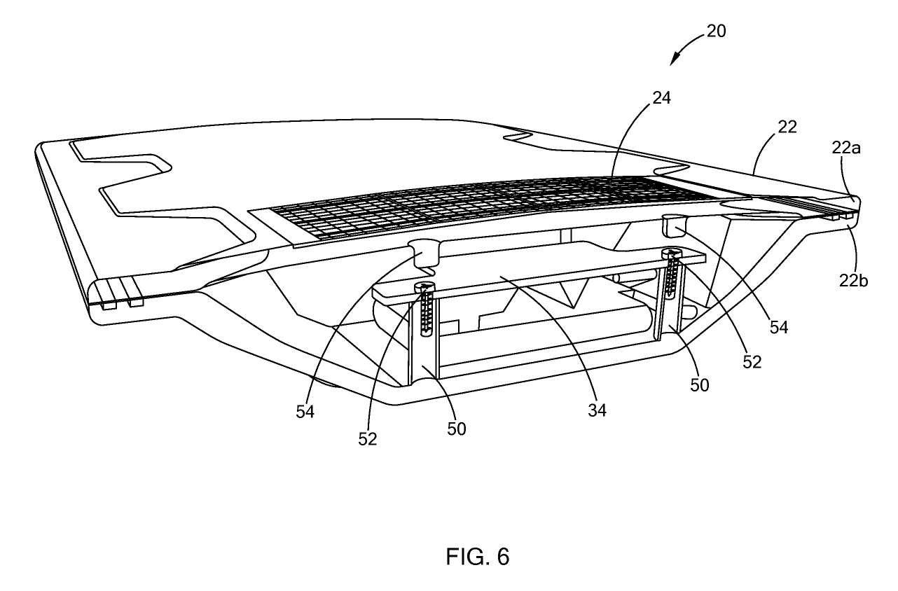

As best seen in FIG. 6, the housing 22 provides a unique support structure for the solar cell 24. In particular, the housing body 22b includes a plurality of posts 50 which can be used to mount the PCB 34 using a mechanical fastener 52, such as a screw or bolt driven into the post 50. A lower surface of the lid 22a is also molded to define corresponding knobs 54 which are vertically aligned with the post 50 and fasteners 52. Further, the lid 22a has a bowed curvature, namely a concave curvature facing the body 22b, which essentially provides an arch structure providing resistance against external forces on the lid 22a. The material of the lid 22 will allow for bending under a sufficient force. However, due to the size, shape and alignment of the knobs 54 with the posts 50 and fasteners 52, the amount of flexure of the lid 22a is limited to prevent the housing 22, the solar cell 24, or the electrical components such as the PCB 34, from being damaged. Any number of corresponding knobs 54 and post 50 may be located throughout the housing 22 to provide adequate support across the upper surface area of the tracking device 20.

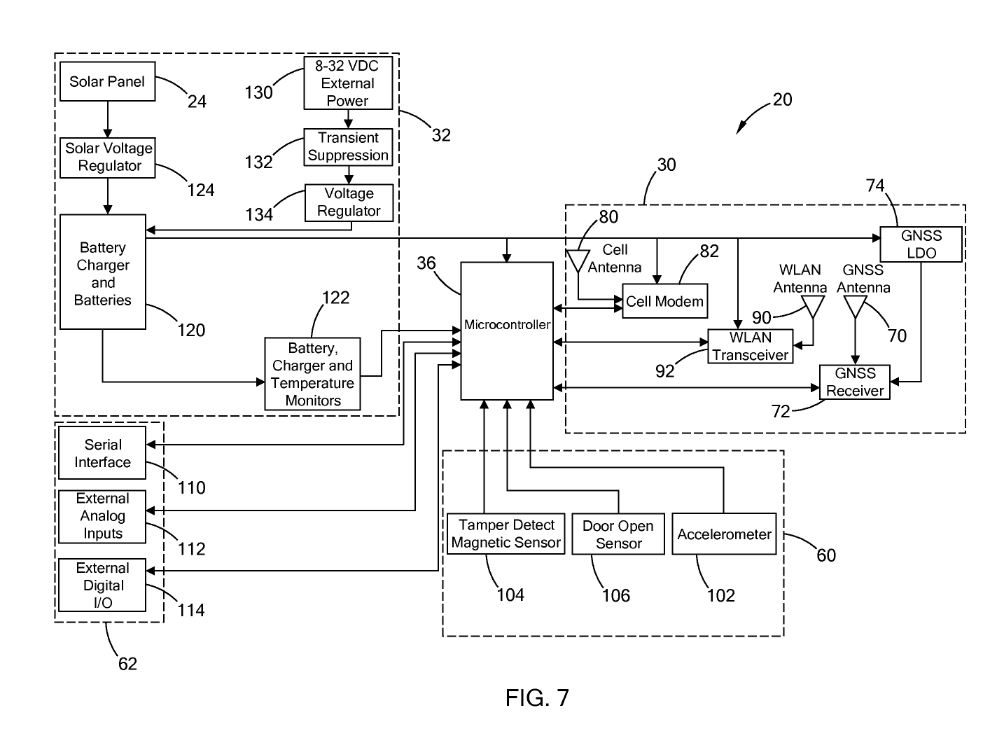

Turning now to FIG. 7, a schematic of the tracking device 20 has been depicted. The microcontroller 36 is a microprocessor programmed for executing the functions described hereinbelow, and includes interfaces for controlling the GPS receiver, cell modem, WLAN transceiver, analog inputs for monitoring voltages, and digital input/outputs for turning devices on and off and monitoring the state of switches and devices. The microcontroller 36 generally interconnects the communication system 30, the power system 32, and optionally a sensor system 60 and an interface system 62. The communication system 30 includes a satellite antenna 70, which preferably is a Global Navigation Satellite System (GNSS), coupled to a GNSS receiver 72. Such satellite systems are well known and may include the global positioning system (GPS; United states), (Glonass; Russia), (Galileo; Europe), (Compass; China) and others, either individually or in combination. The GNSS receiver 72 is provided with power through a low-dropout regulator (LDO) 74 that receives electricity from the power system 32. The GNSS receiver 72 communicates with the microcontroller 36 to provide information regarding the location of the tracking device 20.

The tracking device 20 communicates its location and status to a back office application (not shown) via a a cellular antenna 80 and transceiver 82. The cellular transceiver 82 can be implemented as a Global System for Mobile Communications (GSM)/General Packet Radio Service (GPRS) (GSM/GPRS), or Code Division Multiple Access (CDMA) depending on the cellular carrier that is used. One preferred cellular transceiver 82 or modem is the Lisa U200 provided by U-Blox which a world wide WCDMA (UMTS) and GPRS/Edge unit having a wide temperature range and low idle mode current. Additionally, the cellular transceiver 82 may also be used to provide location information to the microcontroller 36 such as is currently done with other cellular mobile devices and well known in the art.

Optionally, a Wireless Local Area Network (WLAN) antenna 90 and transceiver 92 may be provided to offer local communication with adjacent tracking devices 20 or other devices on a local area network. Similarly, the WLAN antenna 90 and transceiver 92, when connected in a network, can be used to provide location information to the microcontroller 36 as is well known in the art. Other local area communication protocols may also be used in conjunction with or in place WLAN, such as Bluetooth, Z-Wave or ZigBee communication protocols.

A variety of sensors may be utilized to provide additional information to the microcontroller 36, such as a 3-axis accelerometer 102 which senses whether the tracking device 20 is stationary or in motion. A tamper detect magnetic sensor 104 may be utilized to detect when the tracking device 20 is installed on or removed from a ferrous surface. The sensor 104 is passive and thus requires no power to operate, saving battery power. The sensor 104 may be completely integrated into the housing 22 and so as not to be visible from the exterior. A door open sensor 106 may also be used to detect when a door to the container 10 is opened.

The interface system 62 may include various interfaces such as a serial interface 110 which can be implemented as RS-232, RS-422, RS-485, Firewire, Ethernet, USB, UART and other serial communication architectures as is known in the art. Various external analog inputs 112 or external digital inputs/outputs 114 may be provided to interface with external sensors, switch closures and the like, such as sensors to detect the presence of cargo, temperature and humidity.

The power system 32 includes a battery system 120 to provide power to the communication system 30 and to the microcontroller 36. Various sensors 122 may be provided between the battery system 120 and the microcontroller 36 to monitor the battery, charger and temperature. The battery system 120 is rechargeable, and thus the power system 32 includes the solar panel 24 which outputs electricity to a solar voltage regulator 124 for provision to the battery system 120. It will be recognized that the solar panel 24 and regulator 124 are one renewable energy system that may be used to charge the battery 120 and/or power the communication system 30. For example, a wind energy system may also be employed in place of the solar system. Further, if the tracking device 20 is located near another source of external power 130 (such as a connection to the grid (traditional power outlet) or the electrical system of a truck, other vehicle or remote generator), the device 20 is provided with a transient suppressor 132 and voltage regulator 134 for providing appropriate power to the battery system 120. The external power system may also include a receiver and regulator for wireless charging. Appropriate ports and connectors are optionally provided in the housing 22 for such electrical connections, as needed for each particular application.

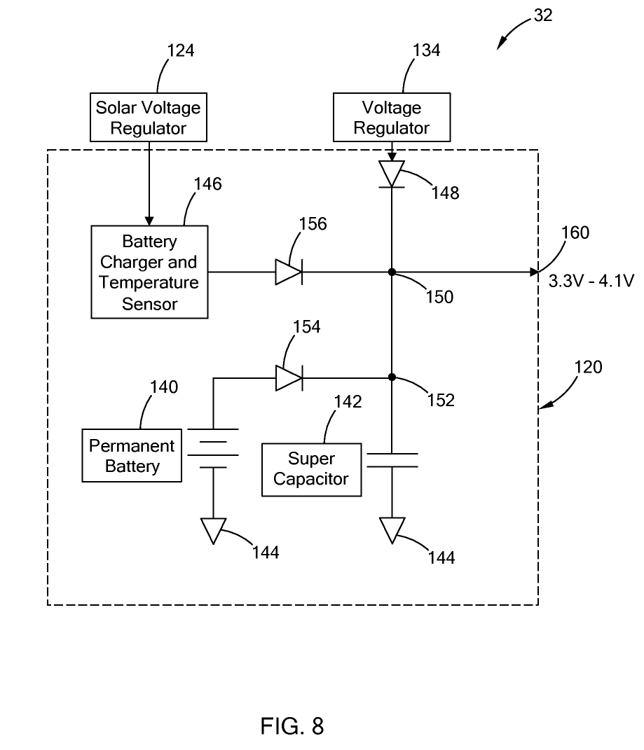

Turning now to FIG. 8, the power system 32, and in particular the battery system 120, is described in greater detail. In order to provide the tracking device 20 with greatly increased lifespan, currently tested to be ten to twenty (or greater) years, a permanent battery 140 is placed in parallel with a rechargeable battery, namely a supercapacitor 142. The permanent battery 140 is a class of permanent batteries that has a large temperature range, a low self-discharge rate and high energy densities that give them a long life in excess of ten years. The rated temperature range preferably meets or exceeds −40° C. to 85° C. These permanent batteries 140 are preferably from the family of lithium/oxyhalide electrochemical cells, and include the chemistries of lithium thionyl chloride, lithium sulfuryl chloride or lithium bromine chloride. Preferably the permanent battery 140 has a nominal capacity of 8.5 Ah at 3 mA, to 2V, a rated voltage of 3.6 V, and an operating temperature range of −55° C. to 85° C. The permanent battery 140 has a maximum pulse current that is insufficient for powering the communication system and microcontroller, and may include a continuous current of 100 mA or less, preferably 75 mA, and a maximum pulse current of 300 mA or less, preferably 200 mA.

While various supercapacitors may be used, such as those of lithium-ion technology, a hybrid layer capacitor (HLC) is preferably used. Super capacitors are generally divided into three families, which include double-layer capacitors with carbon electrodes, pseudocapacitors with the electrodes made of metal oxides or conducting polymers, and hybrid capacitors with special electrodes that exhibit both significant double-layer capacitance and pseudocapacitance, such as lithium-ion capacitors. Most preferably, the supercapacitor 142 is a hybrid layer capacitor that has a rated temperature range that meets or exceeds −40° C. to 85° C. One preferred supercapacitor is has a maximum charge voltage of 3.95 V to 4.1 V, a charge current of 100 mA Max, a charge temperature range of −40° C. to 85° C. (when the charge current is limited to 20 mA), and supports a maximum discharge current of 3.0 A with a 1 second burst (pulse) capacity of 5.0 A. The electrical discharge has a nominal current of 250 mA, end of discharge of 2.5V at room temperature, and a discharge temperature range of −40° C. to 85° C., and has an expected lifetime that exceeds 10 years.

The permanent battery 140 has an output current that is limited to slowly charge the supercapacitor 142. In particular, it is limited to the extent that the permanent battery 140 itself is not suitable for the pulsed loads required by the communication system 30, namely satellite system regulator 74, the WLAN transceiver 92 or the cellular transceiver 82. However, the supercapacitor 142 provides high current bursts of over 3.0 A to meet the demands of the communication system 30. The maximum charge voltage of the permanent battery 140 is preferably less than the maximum charge voltage of the supercapacitor 142, whereby charging of the supercapacitor 142 beyond the voltage of the permanent battery 140 primarily occurs through the solar system 24 or the external power 130.

As seen in FIG. 8, the permanent battery 140 and supercapacitor 142 are connected to a common ground 144 which could also be depicted as a negative lead from the battery system 120, opposite the positive lead 160. When external power is available, the voltage regulator 134 feeds the microcontroller 36, the communication system 30, and/or the battery system 120. Current from the voltage regulator 134 is provided through a first node 150 to the communication system 30 via the positive lead 160, and/or to the supercapictor 142 through a second node 152. A first diode 148 (an external power diode) is utilized to separate the voltage regulator 134 (and the components behind it) from drawing power from the battery system 120, and is positioned between the first node 150 and the voltage regulator 134. In this way, leakage current in the voltage regulator 134 does not drain the battery system 120. A second diode 154 (a battery diode) is positioned between the second node 152 and the permanent battery 140 to prevent current flowing from the voltage regulator 134 to the permanent battery 140 and thereby damaging it.

The solar system (or other renewable energy system) is connected in parallel to the external power source and its voltage regulator 134 across node 150. Power from the solar panel 24 is provided through the solar voltage regulator 124 to the battery system 120. A battery charger and temperature sensor 146 controls the charging of the supercapacitor 142 from the solar panel. The temperature sensor reduces the charge current or turns the charger off entirely when the temperature of the module falls below or goes above the prescribed temperature range, thus protecting it from damage. For example, the charge current would be reduced or turned off when the temperature falls below −20° C. or is above 50° C. Likewise, the device 20 can be programmed to function at the extreme temperature ranges with a reduced number of messages the device has the capacity to send.

The charge current from the solar system is passed through a third diode 156 (a solar diode) positioned between the solar voltage regulator 124 and the first node 150. This prevents the battery charger and temperature sensor 146, or the solar voltage regulator 124, from drawing any power from the permanent battery 140 or the super capacitor 142. As with the external power system, leakage currents in the solar system are prevented from draining the supercapacitor 142. Likewise, the diode 156 prevents any current from the external power 130 from damaging the battery charger and temperature sensor 146 or the solar voltage regulator 124. The second diode 154, by virtue of its position between the second node 152 and the permanent battery 140, prevents current flowing from the solar voltage regulator 124 to the permanent battery 140 and thereby damaging it.

In operation, the permanent battery 140 charges the supercapacitor 142 up to approximately 3.3 V to 3.6 V. The solar panel 24 and/or the external power 130 then charges the supercapacitor 142 up to approximately 4.1 V. When solar power or external power is available, the microcontroller 36 and communication system 30 may operate directly therefrom. When there is no or insufficient light available, or when there is no external power, the microcontroller 36 and communication system 30 can draw current from the supercapacitor 142, which is charged by the permanent battery 140. As noted above, the supercapacitor 142 is well suited for the high bursts of current, such as two amps or greater required by the communication system 30. As power is depleted from the supercapacitor 142, it can be charged by the permanent battery 140. The battery system 120 thus outputs power at 3.3 V to 4.1 V depending on its level of charge and conditions.

Through this unique arrangement, the supercapacitor 142 can be charged by the solar panel 124 or the external power source 130 without damaging the permanent battery 140 due to the diode 154. Likewise, the diodes 148 and 156 prevent the supercapacitor 142 and permanent battery 140 from being drained by the voltage regulator 134, battery charger and temperature sensor 146, or the solar voltage regulator 124.

The diodes 148, 154, and 156 are preferably passive diodes such as Schottky diodes. Alternatively, the diodes 148, 154, 156 may be ideal diodes. As is known in the art, an ideal diode is a semiconductor device which has an extremely large breakdown voltage such that the diode provides a nearly ideal and complete block against the flow of current in one direction. A typical passive diode such as a Shottky diode has a voltage drop of about 0.3 V, whereas an ideal diode has a very low voltage drop of less than 0.1 V. Accordingly, at least the second diode 152, and optionally the first and third diodes 148 and 156 are ideal diodes. In one preferred embodiment, the first diode 148 is a passive diode while the second diode 154 and third diode 156 are ideal diodes. A precision rectifier (super diode) could also be used for any one or combination of the diodes 148, 154, 156.

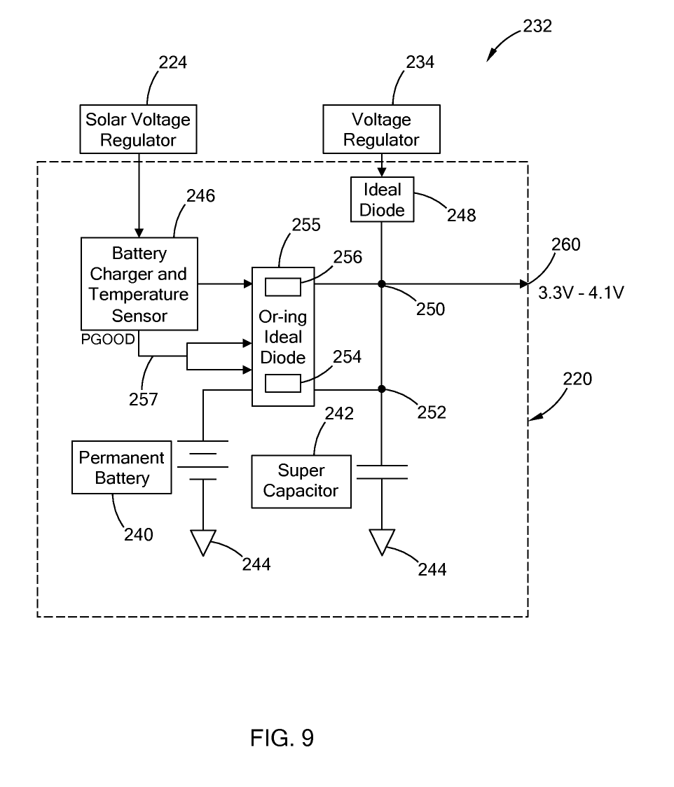

Another embodiment of a power system 232 and battery system 220 are shown in FIG. 9. In this embodiment the external power diode 248 is an ideal diode, while an OR-ing ideal diode 255 operates as the battery diode 254 and solar diode 256. As with the prior embodiment, the battery system 220 includes a permanent battery 240 in parallel with a supercapacitor 242, and solar battery charger 246, to provide power through positive terminal 260. The battery charger 246 receives power from the solar voltage regulator 224, while the external power voltage regulator 234 provides power through diode 248 and node 250.

The OR-ing ideal diode 255 is an integrated circuit that functionally contains two ideal diodes, namely solar ideal diode 254 and battery ideal diode 256 on the same chip. The OR-ing ideal diode 255 also contains enable line circuitry receiving an output signal 257 from the solar battery charger 246. The output signal 257 may be a PGOOD signal, the voltage available from the renewable energy system 24/124/224, or the battery voltage itself, and may also be split (as shown) to provide a software or hardware controlled input for each diode 254, 256. The output signal 257 thus can also be provided to the controller 36 to provide a software or hardware controlled input for each diode 254, 256. The solar battery charger 246 and/or the controller 36 (via hardware or software) can also use parameters such as system voltages (e.g. of the permanent battery 240 and/or the capacitor 242), the charging state, the availability of renewable energy (e.g. solar panel 24) or external power (e.g. source 130), or the temperature, to enable or disable the diodes 248, 254, 256.

When the output signal 257 goes higher, e.g. above a threshold to indicate availability of solar power, the OR-ing ideal diode 255 turns on the solar diode 254 to allow current to flow from the solar panel 24 and its charger 246 to node 250, node 252, and the supercapacitor 242. The same signal 257, when high, also is used to turn off the ideal diode 256 such that the permanent battery 240 is essentially switched off behind node 252. When the output signal 257 is below a threshold, the solar diode 254 is turned off to disconnect the solar system, and battery diode 256 is turned on to permit charging of the supercapacitor 242 from the permanent battery 240 through node 252 and their parallel connection. By way of other examples, when the capacitor 242 is fully charged, or when the temperature is above/below a level where charging is not recommended, the solar diode 254 and/or the battery diode 256 can be turned off. Likewise, charging of the supercapacitor 242 from any source can be controlled based on the state of the communication system or other inputs available to the controller 36, e.g. to prevent charging from the permanent battery when another source is known or likely to be available within a certain time frame corresponding to a remaining charge in the supercapacitor 242 and anticipated loads thereon.

Through the foregoing arrangements, it will be recognized that a tracking system is provided that achieves new levels of useful life through and adaptable power supply and unique construction. The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A tracking device for tracking the location of a container, the tracking device comprising:
a communication system for identifying the location of the container and communicating the location;
a power system for supplying power to the communication system, the power system including a renewable energy system and a battery system, the renewable energy system connected in parallel with the battery system across a first node, the first node electrically connected to the communication system;
the battery system comprising a permanent, non-rechargeable battery connected in parallel with a rechargeable supercapacitor across a second node, the second node electrically connected to the first node;
a battery diode interposed between the first node and the renewable energy system and arranged to prevent the renewable energy system from drawing current from the battery system; and
a solar diode interposed between the second node and the permanent battery and arranged to prevent current being supplied to the permanent battery such that the renewable energy system may charge the supercapacitor without damaging the permanent battery.

2. The tracking device of claim 1, wherein the supercapacitor is a hybrid layer capacitor (HLC).

3. The tracking device of claim 1, wherein the permanent battery has maximum charge voltage that is lower than maximum charge voltage of the supercapacitor.

4. The tracking device of claim 1, wherein the battery system has a positive terminal connected to the first node for outputting current.

5. The tracking device of claim 1, wherein the battery diode is an ideal diode.

6. The tracking device of claim 1, wherein the solar diode is an ideal diode.

7. The tracking device of claim 1, further comprising a voltage regulator for receiving current from an external power source, the voltage regulator connected in parallel to the renewable energy system and the battery system across the first node.

8. The tracking device of claim 7, further comprising an external power diode positioned between the voltage regulator and the first node to prevent the voltage regulator from drawing current from either the battery system or the renewable energy system.

9. The tracking device of claim 1, wherein the permanent battery is from the family of lithium/oxyhalide electrochemical cells.

10. The tracking device of claim 9, wherein the permanent battery is one of a lithium thionyl chloride battery, a lithium sulfuryl chloride battery, and a lithium bromine chloride battery.

11. The tracking device of claim 1, wherein the permanent battery has maximum pulse current that is insufficient for powering the communication system.

12. The tracking device of claim 1, further comprising an OR-ing ideal diode.

13. The tracking device of claim 12, wherein the OR-ing ideal diode is an integrated circuit that functionally contains two ideal diodes comprising the battery diode and the solar diode.

14. The tracking device of claim 1, wherein the battery diode and the solar diode are formed as ideal diodes, and wherein the ideal diodes are enabled or disabled via an input from a controller.

15. The tracking device of claim 14, wherein the input generated by the controller is based on one or more parameters selected from a permanent battery voltage, a supercapacitor voltage, a charging state of the supercapacitor, and a temperature.

16. The tracking device of claim 15, further comprising a battery charging controller positioned between the renewable energy system and the second node, the battery charging controller sending the input to the ideal diodes.

17. The tracking device of claim 16, wherein the battery charging controller includes a temperature sensor for determining the temperature.

18. A method of powering a tracking device for tracking the location of a container, the method comprising:
providing a communication system for identifying the location of the container and communicating the location;
providing a power system for supplying power to the communication system, the power system including a renewable energy system and a battery system, the renewable energy system connected in parallel with the battery system across a first node, the first node electrically connected to the communication system, the battery system including a permanent, non-rechargeable battery connected in parallel with a rechargeable supercapacitor across a second node, the second node electrically connected to the first node, the power system further including a battery diode and a solar diode formed as controllable ideal diodes, the battery diode interposed between the first node and the renewable energy system and arranged to prevent the renewable energy system from drawing current from the battery system, the solar diode interposed between the second node and the permanent battery and arranged to prevent current being supplied to the permanent battery such that the renewable energy system may charge the supercapacitor without damaging the permanent battery;
determining a voltage level of the supercapacitor;
controlling the battery diode and solar diode based on the voltage level of the supercapacitor and an available voltage from the renewable energy system.

19. The method of claim 18, wherein the step of controlling the battery diode and solar diode prevents charging of the supercapacitor from the permanent battery when there is power available from the renewable energy system.

20. The method of claim 18, wherein power system includes a battery charger controller having temperature information, and wherein the step of controlling the battery diode and solar diode is further based on the temperature information.
